(19) United States
(12) Patent Application Publication
(10) Pub. No.: US 2010/0164789 A1
(43) Pub. Date: Jul. 1, 2010

(54) Measurement Level Integration of GPS and Other Range and Bearing Measurement-Capable Sensors for Ubiquitous Positioning Capability

(75) Inventor: Chaminda Basnayake, Windsor (CA)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/605,569

(22) Filed: Oct. 26, 2009

Related U.S. Application Data
(60) Provisional application No. 61/141,297, filed on Dec. 30, 2008.

(51) Int. Cl. G01S 19/45

(52) U.S. Cl. 342/357.04

(57) ABSTRACT

A system and method are provided for determining a position of a host vehicle using a real time kinematics positioning technique when less than an optimal number of satellites are available for determining the position of the host vehicle. GPS data is retrieved from the host vehicle. GPS data is retrieved from vehicles remote from the host vehicle. Alternative vehicle position related data is retrieved. The position of the host vehicle is determined utilizing the real time kinematics positioning technique as a function of the retrieved GPS data of the host and remote vehicles and the alternative vehicle position data. The position of the host vehicle is utilized in a vehicle application.

### CROSS-REFERENCE TO RELATED APPLICATIONS

This application claims priority of U.S. Provisional Application Ser. No. 61/141,297 filed Dec. 30, 2008, the disclosure of which is incorporated by reference.

### BACKGROUND OF INVENTION

An embodiment relates generally to GPS positioning of moving or stationary entities using real time kinetics (RTK) or similar processing methods.

Global Positioning System (GPS) or other Global Navigation Satellite System (GNSS) receivers operate by tracking line of sight signals. These receivers typically require at least four or more satellites to be continuously available in an unobstructed line of sight of a satellite receiver on a vehicle. Due to natural and man-made obstructions (e.g., buildings) or natural obstructions (i.e., dense tree cover), the optimum number of satellites required to accurately determine a position of the satellite receiver may not be available under certain conditions. Other errors such as orbital errors of a satellite, poor geometry, atmospheric delays, multi-path signals, or clock errors may cause the number of satellites to become less than what is used to accurately determine the position of the receiver. What is needed is a method and system for overcoming the issue when a number of satellites required for accurate position identification are not present.

### SUMMARY OF INVENTION

An advantage of an embodiment of the invention is the capability of determination of an absolute or relative position of a vehicle when less than a minimum number of satellites (otherwise required if only GPS was used) are available for determining an absolute or relative GPS position.

In an embodiment of the invention, a method is provided for determining a position of a host vehicle using a real time kinematics positioning technique when less than an optimal number of satellites are available for determining the position of the host vehicle. GPS data is retrieved from the host vehicle. GPS data is retrieved from vehicles remote from the host vehicle. Alternative vehicle position related data is retrieved. The position of the host vehicle is determined utilizing the real time kinematics positioning technique as a function of the retrieved GPS data of the host and remote vehicles and the alternative vehicle position data. The position of the host vehicle is utilized in a vehicle application.

In an embodiment of the invention, a vehicle positioning system includes a host vehicle global positioning system for determining a global position of a host vehicle. A vehicle-to-entity communication system is provided for exchanging GPS data and alternative vehicle position data between a host vehicle and remote vehicles. A processing unit stores GPS measurement data from remote vehicles. The GPS measurement data of the remote vehicles and the host vehicle are processed within the processing unit for determining precise positioning of the host vehicle utilizing a real time kinematics positioning technique. The alternative vehicle position data is processed in cooperation with data output from the real time kinematics positioning technique to compensate for less than an optimum number of satellites required for the real time kinematics position processing technique applied between the host vehicle and the remote vehicles.

### BRIEF DESCRIPTION OF DRAWINGS

FIG. 1 is a diagrammatic representation of a satellite orbiting system such as the Global Navigation Satellite Systems (GNSS) used for GPS.

FIG. 2 is a diagrammatic representation of satellite orbiting system with time delay.

FIG. 3 schematic of a navigation signal modulated into a carrier frequency.

FIG. 4 is a graphical representation of a RTK positioning method.

FIG. 5 is block diagram of positioning determination system capable of using RTK technology.

FIG. 6 is a graphical illustrate of a message set that can be used for vehicle-to-vehicle and other entity communications.

FIG. 7 is a diagrammatic representation of vehicles communicating with a host vehicle while using mostly GPS with the potential aiding of range measurements from communication devices.

FIG. 8 is a diagrammatic representation of host vehicle communication using V2X communication and vehicle sensor technology for position determining when roadside V2X capability is available.

FIG. 9 is a diagrammatic illustration of a host vehicle utilizing vehicle sensing technology for position determining.

FIG. 10 is a flow diagram of a method using an alternative vehicle sensor measurement data in cooperation with RTK or similar GPS position technology for determining absolute or relative positioning.

### DETAILED DESCRIPTION

The global positioning satellite constellation includes at least 24 or more satellites orbiting the earth in a predetermined path of travel continuously transmitting time marked data signals. Navigation satellite receivers receive the transmitted data and use this information to determine its absolute position. In viewing the earth in a two dimensional plane, each point on the earth is identified by two coordinates. The first coordinate represents latitude and the second point represents a longitude. To determine a position in the two dimensional plane, at least three satellites are required as there are three unknowns, two position unknowns and the receiver clock timing error which also treated as an unknown. Some receivers may assume that the altitude stays the same for short duration such that position can be determined with only three satellites; however, if altitude is taken into consideration which is the case for most applications, then at least a minimum of four satellites are required to estimate an absolute position with a certain amount of error. By using four or more satellites, an absolute position in a three dimensional space can be determined that includes the height above and below the earth's surface (e.g., sea level).

Satellite receivers operate by tracking line of sight signals which requires that each of the satellites be in view of the receiver. By design, GPS and other GNSS ensure that on average, four or more satellites are continuously in the line of sight of a respective receiver on the earth; however, due to urban canyons (i.e., obstructions such as buildings) a lower number of satellites may be in the line of sight, and even more so, obstructions may result in a lower number of satellites than that which is required to accurately determine the position of the satellite receiver. Other positioning errors that can occur include orbiting errors (i.e., when a satellite's reported position does not match its actual trajectory due to errors or limitations in the models used), poor geometry (i.e., satellites clustered within a narrow region of the sky with respect to the view of the receiver), multi-path signal (i.e., signals reflected off buildings and other objects), atmospheric delay (i.e., delays occurring when the signals pass through the earths atmosphere, and clock errors (i.e., clocks built into a receiver being inaccurate or deviations in satellite clocks).

The location of a navigation satellite receiver is determined by first comparing the time the signals were transmitted from each of the respective satellites versus the time the signals were recorded and then correcting for some of the errors as described in Par. [0014]. In response to the comparison and the estimates of the location of each satellite using transmitted data, the receiver calculates how far away each satellite is from the receiving device. Provided this information, the receiver not only determines its position, but the receiver can determine speed, bearing, distance and time to a destination and other information.

In a considerably simplified approach, each satellite sends out signals with the following content: a satellite identification code, the parameters of predefined models that enables the estimation of satellite's position and certain errors (i.e., satellite clock error and atmospheric errors), and the time at which the information was sent. In addition to its position, each satellite sends data about the position of other satellites. This orbit data (ephemeris and almanac data) are stored by the GPS receiver for later calculations.

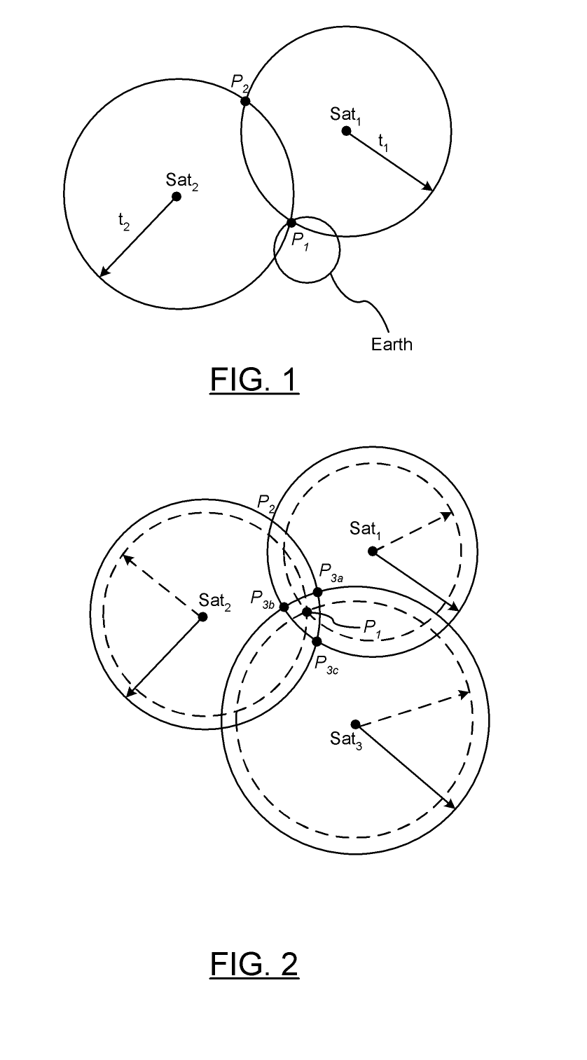

The following provides an explanation of how position determination by a GPS works. For simplification purposes, first assume the earth is a two-dimensional plane (this can later be related to a model of a three-dimensional globe). The time needed by a signal to travel from a first of two navigation satellites to the GPS receiver is recorded at t₁ (e.g. 0.07 sec.). Provided this information, it can be determined that the receiver is positioned somewhere on a circle with a radius of t₁ around the first satellite. If the same procedure is performed with a second satellite having a distance time of t₂, then two points of intersection (P₁ and P₂) are produced as shown in FIG. 1. If ideal measurements (i.e., no errors) were available, points P1 and P2 should have coincided at the location of the receiver. In reality, receivers use mathematical techniques to estimate the most likely location of the receiver by minimizing the residual errors. This process becomes more accurate as more satellite observations are added to the process as the redundancy increases. The time ambiguity is resolved by the time stamp on each of the transmitted signals. It is well known that all clocks of satellites are for the most part precise (i.e., using atomic clocks); however, the clock errors mostly result from the clock in the GPS receiver. If it is assumed that the clock in the GPS receiver is 0.005 sec early compared to the clock in the satellite, then the runtime of the signal will appear to be 0.005 seconds longer than it actually is. This may result in a determination that the GPS receiver is located on one of the points P₃ instead of P₁. The intersections of the circles that intersect at P₃ₐ, P_{3b}, P_{3c} are called pseudo ranges. The term “pseudo” is in reference to no correction of the synchronization errors of the clocks being performed.

Based on the accuracy of the clock of the GPS receiver, the determined position could be incorrect due to remaining error. For example, a clock error of 1 millisecond in a GPS navigation system would result in an error of around 300 km in the user-satellite range measurement. Therefore, if a third satellite is taken into account (in a 2D positioning system), then the absolute position P₁ is obtained. In the example where the clock was 0.005 sec early, the three intersection points P_{3a-c} are clearly identified (see FIG. 2), and the clock error is readily shown. The time of the GPS receiver clock which is common to all measurements may be shifted until the three intersection points P_{3a-c} are united to P₁. As a result, the clock error is estimated and then the receiver clock is synchronized.

In the example of a three dimensional global positioning system where it is assumed that the earth is not perfectly spherical (i.e. mountains, above or below sea level), a fourth satellite is used which corresponds to the altitude as it relates to a location on the earth based on a world geodic system standard (WGS-84). Therefore, to determine an absolute position in the three dimensional global positioning system, four or more satellites are required.

The principle of position determination by a GPS and the accuracy of the positions strongly depend on the nature of the signals. A variety of criteria is considered in the development of a suitable signal structure. In consequence, the GPS signal is quite complex and offers the possibility of accounting for the following parameters: one-way (passive) position determination, exact distance and direction determination (Doppler effect), transmission of navigation information, simultaneous receiving of several satellite signals, provision of corrections for ionospheric delay of signals and certain level of insusceptibility against interferences and multi path effects. In order to fulfill all these requirements, the signal structure described below was developed.

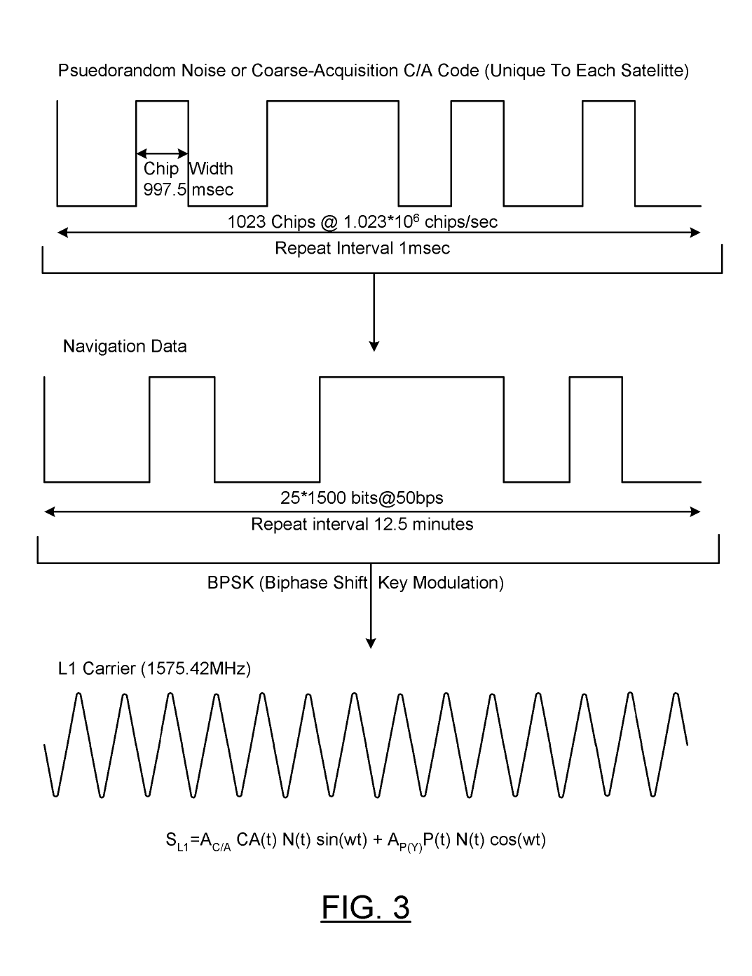

FIG. 3 illustrates the signal broadcast by the respective satellites. Broadcasting of the GPS signals from the GPS navigational satellite requires a suitable carrier frequency. A selection of the carrier frequency is based on the certain requirements and constraints as described herein. The frequencies selected should be less than 2 GHz as frequencies greater than 2 GHz require beam antennae for the signal reception. In addition, the speed of the propagation of a signal in the air deviates from the speed of light as the frequency is lowered. Also, large delays in the ionosphere occur for frequencies greater than 10 GHz and less than 100 MHz.

PRN-codes are modulated onto the carrier frequency and require a high bandwidth for the code modulation. As a result, a range of high frequencies with a high bandwidth should be selected. In addition, the frequency selected should be in a range where the signal propagation is not influenced by weather phenomena like, rain, snow or clouds.

Each GPS satellite currently transmits two carrier signals in the microwave range, which are designated as L1 and L2 (L1 centered at 1575.42 MHz and L2 centered at 1227.60 MHz). A third frequency is currently in a test phase and is designated as L5 centered at 1176.45 MHz. In the current civilian signal range (L1 C/A), the carrier phases are typically modulated by two different binary codes: first there is the C/A code (coarse acquisition). This code is a 1023 “chip” code, being transmitted with a frequency of 1.023 MHz. The term “chip” is used synonymously with the term “bit” and is also described by the numbers “1” or “0”; however, no information is carried by the signal when using a chip. The carrier signals are modulated and the bandwidth of the main frequency band utilizes a spread frequency spectrum from 2 MHz to 20 MHz for reducing interference. The C/A code is a pseudo random code (PRN) which resembles a random code with unique auto correlation and cross correlation properties but it is defined for each satellite. The PRN is repeated every 1023 bits (i.e., 1 msec). Therefore, in 1 second, 1.023 (10⁶) chips are generated.

As described earlier, each GPS navigation satellite is identified by the GPS receiver using the PRN-codes. The PRN-codes are only pseudo random. In reality, if the codes were actually random, 2¹⁰²³ possibilities would exist. Of these many codes only some are suitable for the auto correlation or cross correlation which is necessary for the measurement of the signal propagation time.

In the GPS system, the data is modulated onto the carrier signal using phase modulation, more specifically biphase shift key modulation (BPSK) in the L1 C/A signal. Different modulation methods are also used in other signals. When a data signal is modulated onto a carrier signal by phase modulation, the sine oscillation of the carrier signal is interrupted and restarted with a phase shift (e.g. 180°). The phase shift is recognized by a GPS receiver and the data is restored.

In addition to the C/A code, other GPS required information in the signal is modulated into the L1 signal. The information consists of a 50 Hz signal and contains data like satellite orbits, clock corrections, and other system parameters (information about the status of the satellites). Such data is constantly transmitted by each satellite. Based on the information received in the signal, the GPS receivers acquire information such as the date, the approximate time, and the position of the satellites.

The data signal from the GPS navigational satellite contains a correction parameter for the satellite clock. Even though each satellite carries one or more atomic clocks onboard and maintains very accurate time, atomic clocks of the individual satellites are not perfectly synchronized to the GPS reference time; rather each runs on their own. Therefore, correction data for the each clock of each satellite is required. In addition, the GPS reference time is different from world time which is synchronized with the rotation of the earth. World time and GPS time are synchronized by means of leap seconds. If a GPS navigational satellite fails to transmit data correctly or if the GPS navigation satellite's orbit is unstable, the instability will be identified in the broadcast signal, and as a result, a respective GPS navigational satellite may not be used for determining the position.

When comparing two identical codes (i.e., received code and locally generated code) to align the codes, the GPS receiver first determines if there is an error and then determines how far the signals have to be shifted until they are aligned. The distance that the signals must be shifted corresponds to a time, that is, a part of the runtime of the signal from the satellite to the receiver. It is understood that the C/A code is composed of 1023 chips, transmitted with 1.023 MHz, and repeated every 1 msec. Modern GPS receivers can calculate its position with an accuracy of around 3 meters and this is a function of receiver capabilities and the residual errors. However, to obtain more precise positioning, positional accuracy can be enhanced using GPS carrier phase and differential processing such as real time kinematics (RTK) processing which uses carrier phase information of GPS signals.

RTK positioning is a technique whereby a single or multiple reference base station (or stations) provides in real time corrections or raw observation data for GPS positioning between a base station and a remote. Such positioning can be estimated to a centimeter level of accuracy. In conventional GPS positioning, residual errors in the GPS observations result in positioning errors in the orders of meters. Atmospheric errors are usually the largest and all other error source may have residual errors. RTK follows the concept of differencing observations (single and double differencing between satellites and between rover and base station) whereby the residual errors are almost eliminated when the rover and the base station are within tens of kilometers from each other. RTK utilizes the satellite's carrier phase as its basis for determining real-time orientation of the receiver's position on the earth. The RTK method relies on the differencing techniques to eliminate or minimize common errors without depending on using the data in the transmitted signal for this purpose.

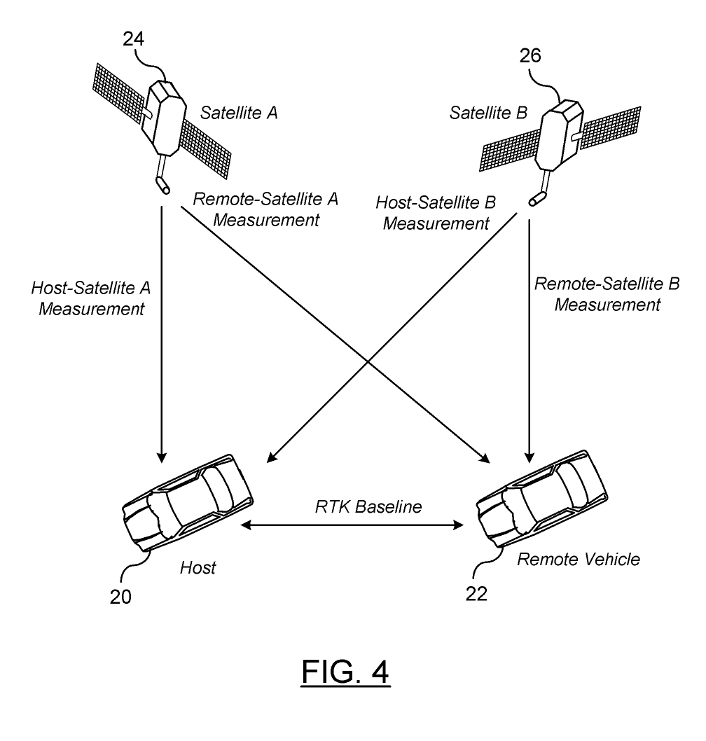

The RTK method is illustrated in FIG. 4. It shows a reference base station 20 having a known position. Conventional RTK assumes the base station 20 to be fixed but the same concept can be used for a moving base station. Also shown is a remote GPS receiver 22 such as that of a GPS unit of a vehicle. Also shown orbiting around the earth is an exemplary number of navigational satellites 24 and 26 (typically more than four satellites required). The navigational satellites broadcast signals over a respective carrier frequency as described above. Under the RTK positioning technique, RTK systems utilize the single base station receiver 20 and a number of mobile units 22. The base station 20 re-broadcasts GPS measurement data which include pseudorange and carrier phase information. The mobile units 22, in turn, compare their own phase measurements with the phase measurements received from the base station 20 through a process known as a “double differenced” carrier phase measurements. As a result, the mobile units 22 can calculate their “relative” position to a high degree of accuracy (e.g., even millimeters). In knowing the base station absolute position, the absolute positioning of the mobile units 22 can be determined with the same degree of accuracy, although their absolute position is only as accurate as the position of the base station. In case of a moving base station, the relative position is estimated to the same accuracy as in the case of a fixed base station. However, the absolute position of the base station 20 and the mobile units 22 can only be accurate as the position of the base station double differenced carrier phase measurements are obtained by first subtracting the user observations (i.e., remote receiver) from the reference observations (i.e., reference base station). This portion of the measurement is known as a “single difference” measurement. Following the single difference measurement, a determined signal difference from one satellite is subtracted from all the other satellite signal differences. The results are converted to a user reference baseline estimation problem. The baseline can be determined to centimeter level accuracy when the carrier ambiguities are resolved. This technique requires carrier phase ambiguity resolution. In general, the remote receivers process the information to solve the WGS-84 vectors in real-time within the receivers to produce an accurate position relative to the base station having a known position. The known position of the base station in cooperation with accurate positioning of the mobile receivers relative to the base station provides a GPS position with 1-2 centimeter accuracy. The advantages of using the RTK technique are that common errors resulting from the satellite (e.g., orbiting errors), atmosphere, and user clock are substantially eliminated or minimized when using the carrier phase information set forth in the RTK technique.

As described above, the RTK technique as well as conventional GPS processing technique work well when a required minimum number of navigation satellites are available (i.e., within line of sight). If the requisite number of navigation satellites are not available due to obstructions within the line of sight of the navigational receiver, such as in the case of urban canyons, tree covered areas, tunnels, covered parking lots, etc., then the ability to accurately determine the remote GPS receiver's position is diminished. To overcome this deficiency, an embodiment of the invention uses the inclusion of in-vehicle sensor measurements and V2X communications of remote vehicles that have a number of navigational satellites in common with the host vehicle. The in-vehicle sensing devices of the host vehicle and/or alternative positioning data from remote vehicles provided to the host vehicle through V2X communications can be used in cooperation with the RTK processing technique to accurately identify the location of the GPS navigational receiver in both a relative and in an absolute sense. That is, the requisite number of satellites required to obtain accurate positioning can be lowered, potentially down to two navigational satellites by utilizing other vehicle sensors capable of measuring range and/or bearing. Such range and bearing data may be obtained by systems that include, but are not limited to, vision systems with target tracking, ultra wideband (UWB) using in-vehicle transponders/receivers in vehicles, V2X communications which include vehicle-to-vehicle (V2V) communication with other vehicles having GPS coverage and vehicle-to-infrastructure (V2I) communications that include roadside units (RSU)/beacons with GPS coverage. Mathematical modeling is performed using the range and bearing data to obtain results that are in a form that can be processed in cooperation with the RTK position processing techniques to compensate for the insufficient number of satellites typically required for RTK position processing.

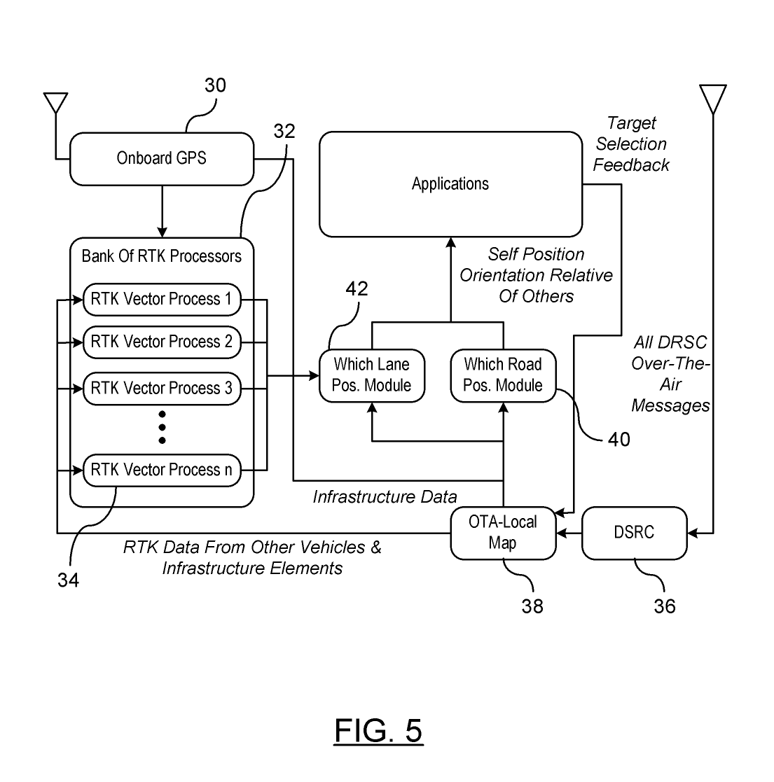

FIG. 5 illustrates a block diagram for a positioning determination system using RTK technology. A vehicle includes an onboard GPS unit 30 having a GPS or other GNSS receiver for receiving navigation signals from one or more navigation satellites. The GPS unit 30 includes a bank of RTK processors 32 for performing RTK position processing. The bank of RTK processors 32 maintains a list of RTK vector processes 34 for each respective vehicle or other entity that is within its communication range. Given the respective RTK vector information derived for each vehicle or entity is stored in the bank of RTK processors 32, the GPS unit 30 uses the RTK technique to determine the relative position of each communicating entity with respect to the host vehicle.

The vehicle is equipped with a dedicated short range communication (DSRC) radio or other communication device 36 for V2X communication with other vehicles and/or infrastructures. The system uses a dedicated short range communication, WiFi, or like system, as the communication protocol for V2X communication. V2X communication includes, but is not limited to, vehicle-to-vehicle (V2V) communication and vehicle-to-infrastructure (V2I) communication. V2V communications are co-operative vehicle communication systems based on two-way communications for interacting in real time between vehicles. These systems are preferably directed at traffic management, collision warning, and collision avoidance systems licensed for public safety applications. Such systems can extend a host vehicle's range of awareness of environmental conditions by providing relevant information regarding the status of traffic in addition to any safety related events occurring in proximity to those neighboring vehicles of the host vehicle. Included in the communication is global positioning of neighboring vehicles that is periodically transmitted to neighboring vehicles as part of a fixed time based message.

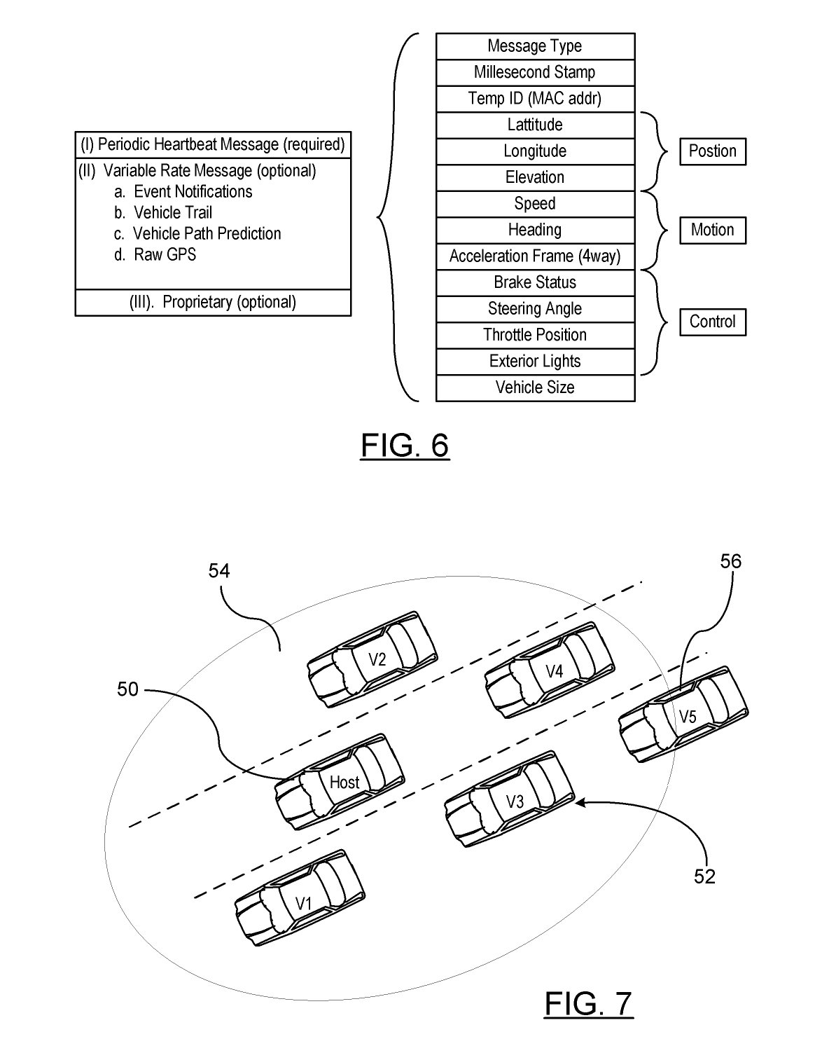

An example of a DSRC message set and the type of information contained therein is illustrated in FIG. 6. The message includes three categories of information. A first category includes a periodic heartbeat-like message that provides health status information of a vehicle's system status. A second category is an optional category that includes variable rate messaging data. Such data may, include but is not limited to, event notifications, vehicle trail/breadcrumbs, vehicle path prediction, and raw GPS data for RTK-like method (e.g., SAE J2735) support for RTK data sharing). A third category may include propriety information. The first category includes a plurality of identifiers concerning the vehicles status. Among these identifiers includes, but is not limited to, the position of the vehicle (e.g., latitude, longitude, and elevation), the motion of the vehicle (e.g., speed, heading, and acceleration), and other information such powertrain, braking, and steering controls.

V2I communications are communications which are communicated between a vehicle and an infrastructure, such as roadside units (RSU) or access points (AP). Information provided from neighboring vehicle or servers relating to neighboring vehicle positions and other information may be used similar to that described for the positioning used in V2V communications.

Other applications for obtaining alternative relative positioning data may include in-vehicle application object sensing devices. Such devices may include devices that measure or estimate a position of the host vehicle relative to a neighboring vehicle. For example, range and bearing measurements to a neighboring vehicle may be obtained through Ultra Wide Band (UWB) communications or from various object detection sensing systems including, but not limited to, vision sensing devices, radar sensing devices, ultrasonic, or light-sensing devices (e.g., lidar devices).

Referring again to FIG. 5, the information received by the DRSC, or similar device, is provided to an over-the-air-local map processing block 38. The data received at this block may be used in the positioning determination of the RTK positioning technique of block 32. For example, RTK requires that each of the surrounding vehicles or other entities (RSU) have a predetermined minimum number of common satellites for determining a relative position using the RTK positioning technique. Optimally, 4 or more satellites are required if 3D position is required for the determination of the position of the receiver; otherwise, a lesser number of satellites are required if certain unknowns are assumed to be known or constants. One example would be assuming a fixed height, in which case the solution may be called a height-fixed solution. Therefore, V2X communications with other vehicles allows the host vehicle to communicate with remote vehicles in its broadcast zone for determining whether they have a sufficient number of common satellites in their line of sight to implement the RTK positioning technique for enhancing the accuracy of the host vehicle's absolute or relative position.

Other data received from block 38 may be used to establish both relative positioning of the host vehicle with respect to the remote vehicles or may be used in to compensate for a lack of data when an insufficient amount of common satellites are available when utilizing RTK position processing. Relative positioning is warranted when a position of the remote vehicles relative to a host vehicle is demanded with high accuracy. Such an example includes a road location module shown at block 40. If a navigation unit or other type of vehicle application requires only information as to the road host vehicle is traveling on, then precise positioning of the vehicle is not require within the road is not required. This level of accuracy may be called the which-road level accuracy. In this example, the host vehicle may use latitude and longitude data from other vehicles, infrastructures with its own GPS to estimate the relative position of the other vehicle. Although the latitude and longitude data may have errors associated with its position (1-3 meter accuracy), this is not an issue as the position of the host vehicle, as required by the application seeking the information only to determine which road the vehicle is traveling along and not necessarily its precise position in the road.

Absolute or relative positioning with great accuracy is warranted when a substantially exact position of the host vehicle is demanded. Such an example includes a road location module shown at block 42. Such an example includes a lane positioning module that requires greater accuracy since the applications involved require the absolute or the relative position of the host vehicle. For example, the application may include a lane departure warning which requires knowledge as to which lane in the road the vehicle is positioned within. Another example may include a Forward Collision Warning (FCW) which requires which lane the vehicle is traveling in. In block 42, the host vehicle utilizes information obtained from other vehicles such as V2X communication or in-vehicle objected detection sensing devices. Typically, the in-vehicle object sensing devices provides a relative position of the host vehicle relative to remote vehicles (e.g., bearing and range data). Mathematical modeling using the acquired data is performed to provide a position data that can be used in cooperation with the RTK vector data to generate an absolute position of the vehicle with precision positioning. It should be understood that a plurality of mathematical modeling techniques including, but not limited, to a Least Square approach may be used to convert the object sensing data (e.g., bearing and range data) into a useable form that is complimentary with RTK positioning technique. The use of such mathematical modeling data in cooperation with RTK positioning technique would be used when there is less than the optimum number of common satellites present between the host vehicle and other remote vehicle for executing the RTK processing technique (which is typically derived from GPS information obtained from the remote vehicles). That is, the host vehicle uses mathematical modeling to transform the V2X data containing object sensing information (e.g., range and bearing data) into a useable form that can be cooperatively implemented using the RTK positioning technique.

FIGS. 7-9 include schematic and flow diagrams illustrating the use of V2X communications for determining precision use of alternative positioning data used in cooperation with standard positioning technologies (such as RTK technology).

FIG. 7 shows a host vehicle 50 traveling along respective road. A plurality of vehicles 52 are also shown traveling along the respective road in communication range with the host vehicle via a DSRC radio or similar communication protocol. The region 54 is an obstruction zone in which vehicles located within region 54 are only receiving signals from less than the required number of satellites to establish absolute positioning due to line of sight errors (e.g., being in an urban canyon). Vehicle 56 is disposed outside of region 54 and receives satellite signals from a requisite number of satellites. Therefore, vehicle 56 can estimate its absolute position in response to seeing the required number of satellites. The host vehicle 50 being within region 54 cannot estimate its absolute position as less than minimum number of satellites are available. By utilizing V2V communication between the host vehicle 50 and other vehicles such as vehicle 56, the host vehicle 50 can use partial GPS observation data from vehicle 56 and/or UWB communication capability to determine range or bearing data in its GPS location. The data retrieved by vehicle 56 is more accurate since it is utilizing at least the minimum number of satellites require for absolute positioning. The information obtained from vehicle 56 may include GPS information, or sensed information such as range and bearing information if vehicle 56 senses host vehicle 50 using its sensing devices. Using the range and bearing information provides relative positioning between the host vehicle 50 and vehicle 56 which may thereafter be used to determine absolute positioning of the host vehicle 50.

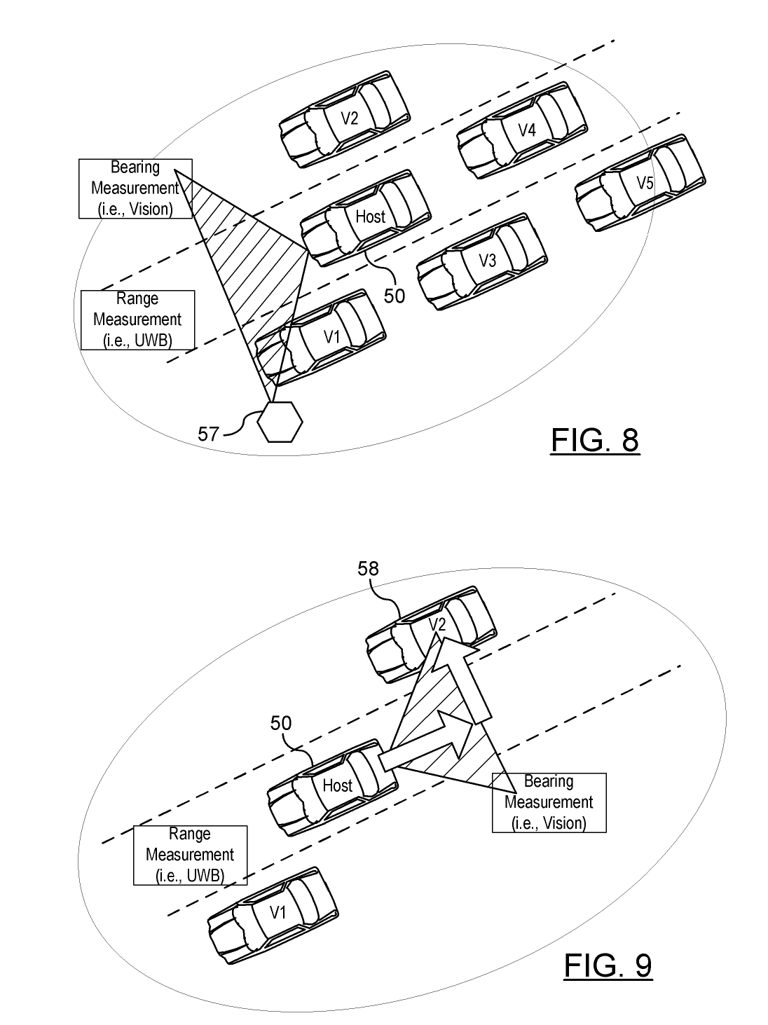

FIGS. 8 and 9 illustrate embodiments of the host vehicle using in-vehicle sensing devices. In FIG. 8, the host vehicle 50 communicates to the RSU 57 using UWB or similar communication technology based messaging. This could be used to generate vehicle-to-RSU range estimates. The bearing with respect to the RSU 57 could be measured by the in-vehicle sensors. Based on the method introduced in this invention, all or some of the above range and bearing measurements could be used in conjunction with GPS information to generate an accurate vehicle-to-RSU relative vector. In the case of not having enough common GPS satellites between the host vehicle 50 and the RSU 57 for traditional RTK, this method allows for the use of available partial GPS information and other vehicle sensor generated information to be combined for increased availability of the position information. If the location of the RSU 57 is precisely known and is communicated to the host vehicle 50 as a part of the messaging, this method enables the vehicle to estimate its absolute location in addition to estimating its relative location with respect to the RSU 57.

FIG. 9 shows a diagrammatic illustration of a host vehicle 50 utilizing vehicle sensing technology for determining a position in comparison to using only GPS in a V2V scenario. In FIG. 9, the in-vehicle sensing devices of the host vehicle 50 are equipped with vision devices or radar devices or any other similar devices. Similar to the concept described for FIG. 8, bearing measurements may be determined by using the vision devices. In addition, vehicle-to-vehicle communication using UWB or similar technology could be used to estimate the range between the vehicles. Therefore in cases where common satellites number between the host 50 and a target vehicle 58 is not sufficient for traditional RTK, additional range and bearing information may be combined with partial GPS information to generate a combined relative positioning solution between the target vehicle 58 and the host vehicle 50. This can be further extended to estimating the absolute position of the host vehicle 50 if the absolute location of the target vehicle 58 is known and is communicated to the host vehicle 50 as a part of the vehicle-to-vehicle message. The arrows in FIG. 9 indicate along and across distances from the host vehicle 50 to the target vehicle 58 which can be obtained by V2V communications. The embodiments shown in FIGS. 8 and 9 allow for enhanced RTK positioning in comparison to a GPS-only RTK positioning scenario when less than an optimal number of a satellites are available to the host vehicle 50.

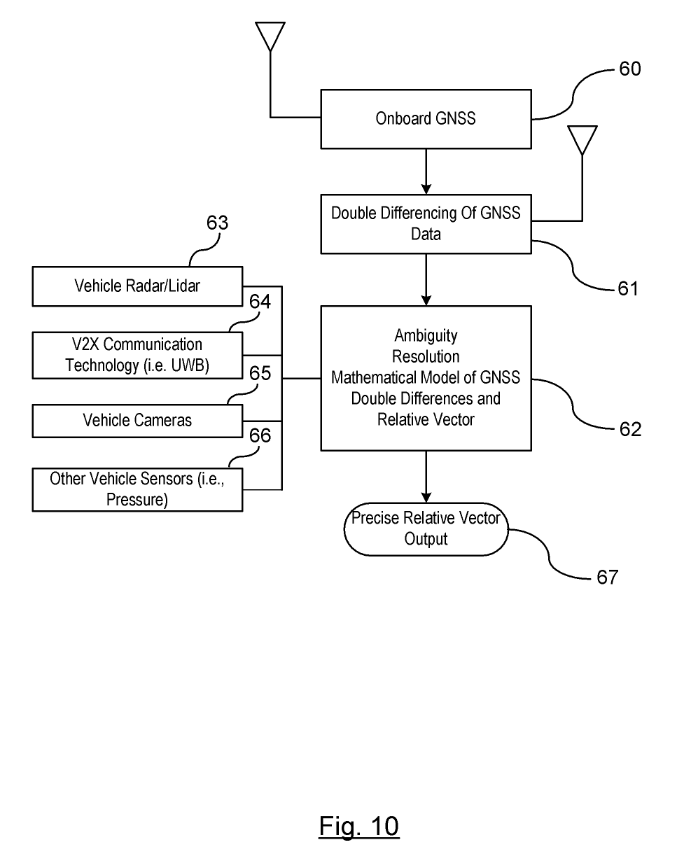

FIG. 10 illustrates a process which can be used to achieve the GPS and vehicle sensor integration illustrated in FIGS. 7, 8, and 9. The on-board global navigation satellite system (GNSS) 60 receives GPS signals from those satellites that are in a line of sight with the host vehicle which is less than the minimum number of satellites required to estimate its absolute position. Data is then processed using double differencing technique using the GNSS data in block 61. GPS data from other remote vehicles having a minimum number of common satellites available is provided to block 61 for utilizing RTK position processing technique. RTK position processing technique may reduce the positioning error to substantially 1-2 centimeters. The GPS data of the remote vehicles is provided to the host vehicle through V2X communication. The data is then provided to block 62 where RTK position processing technique is performed using the acquired GPS data from the other vehicles. If the number of satellites in the line of sight of the host vehicle is less than the minimum number of satellites required for RTK processing, then the host vehicle may use additional measurement observational data obtained by other methods as described herein. Other methods of obtaining the additional measurement observational data includes, but is not limited to, data obtained from vehicle radar, lidar, or ultrasonic devices 63, data obtained from V2X communications 64, vision cameras 65, and other in-vehicle sensors 66. Such data may include range, range rate, bearing, rate of change of bearing, and height difference. The obtained data is provided to a processor where a mathematical model is generated based on the obtained data. The data output by the mathematical model is complimentary to the RTK position processing technique for estimating an absolute position of the host vehicle using the RTK technique. As a result, the data is transformed into a form that supplements the data to processor so that an absolute position or a relative position may be estimated using the RTK positioning technique. In block 67, the precise relative vector is output estimating the absolute location.

While certain embodiments of the present invention have been described in detail, those familiar with the art to which this invention relates will recognize various alternative designs and embodiments for practicing the invention as defined by the following claims.

What is claimed is:

1. A method for determining a position of a host vehicle using a real time kinematics positioning technique when less than an optimal number of satellites are available for determining the position of the host vehicle, the method comprising the steps of:
retrieving GPS data from the host vehicle;
retrieving GPS data from vehicles remote from the host vehicle;
retrieving alternative vehicle position related data;
determining the position of the host vehicle utilizing the real time kinematics positioning technique as a function of the retrieved GPS data of the host and remote vehicles and the alternative vehicle position data; and
utilizing the position of the host vehicle in a vehicle application.

2. The method of claim 1 wherein a mathematical model is generated as a function of the alternative vehicle data, wherein the generated mathematical model is in a form that can be processed in cooperation with the real time kinematics positioning technique.

3. The method of claim 2 wherein a mathematical approach is used to convert the alternative vehicle data into a form that is complementary with the real-time kinematics positioning technique.

4. The method of claim 3 wherein the mathematical approach includes a Least Square mathematical approach.

5. The method of claim 1 wherein the GPS data is obtained from the remote vehicles that are receiving data from satellites in common with the host vehicle.

6. The method of claim 1 wherein the alternative position data is obtained from vehicle-to-vehicle communications between the host vehicle and the remote vehicles.

7. The method of claim 1 wherein the alternative position data is obtained from vehicle-to-infrastructure communications.

8. The method of claim 1 wherein the alternative vehicle data is obtained from in-vehicle object detection sensing devices.

9. The method of claim 1 wherein the alternative vehicle data includes range and bearing data generated by the host vehicle.

10. The method of claim 1 wherein the alternative vehicle data includes range and bearing data generated by the remote vehicles.

11. The method of claim 1 wherein the GPS data of the remote vehicles are provided to the host vehicle via vehicle-to-vehicle communications.

12. The method of claim 1 wherein the GPS data of the remote vehicles are provided to the host vehicle via vehicle-to-infrastructure communications.

13. The method of claim 1 wherein the determined position of the host vehicle is a position relative to the remote vehicles.

14. The method of claim 1 wherein the determined position of the vehicle is an absolute position.

15. The vehicle positioning system comprising:
a host vehicle global positioning system for determining a global position of a host vehicle;
a vehicle-to-entity communication system for exchanging GPS data and alternative vehicle position data between a host vehicle and remote vehicles; and
a processing unit for storing GPS measurement data from remote vehicles, the GPS measurement data of the remote vehicles and the host vehicle being processed within the processing unit for determining precise positioning of the host vehicle utilizing a real time kinematics positioning technique;
wherein the alternative vehicle position data is processed in cooperation with data output from the real time kinematics positioning technique to compensate for less than an optimum number of satellites required for the real time kinematics position processing technique applied between the host vehicle and the remote vehicles.

16. The method of claim 14 wherein a mathematical model is generated as function of the alternative vehicle data and is used to convert the alternative vehicle data into a form that is complementary with the real-time kinematics positioning technique.

17. The method of claim 14 wherein the GPS data is obtained from the remote vehicles that are receiving data from satellites in common with the host vehicle.

18. The method of claim 14 wherein the vehicle-to-entity communication system is a vehicle-to-vehicle communication system.

19. The method of claim 14 wherein the vehicle-to-entity communication system is a vehicle-to-infrastructure communication system.

20. The method of claim 14 wherein the alternative vehicle position data includes range and bearing data generated by the host vehicle.

21. The method of claim 14 wherein the alternative vehicle data is generated by at least one remote vehicle and is communicated to the host vehicle.
